(19) United States
(12) Patent Application Publication
(10) Pub. No.: US 2026/0196598 A1
(43) Pub. Date: Jul. 9, 2026

(54) Connector and Connector Assembly

(71) Applicant: Illinois Tool Works Inc., Glenview, IL (US)

(72) Inventor: Cong Cao, Shanghai (CN)

(21) Appl. No.: 19/439,147

(22) Filed: Jan. 2, 2026

(30) Foreign Application Priority Data
Jan. 8, 2025 (CN) 202510028554.0

(51) Int. Cl. H01M 10/6554; F28F 9/06; H01M 10/613

(52) U.S. Cl. CPC H01M 10/6554; F28F 9/06; H01M 10/613

(57) ABSTRACT

The present disclosure provides a connector (100) comprising a supporting seat (101) and a connecting pipe (120). The supporting seat (101) has a first side (111) and a second side (112) opposite to each other and comprises a supporting seat channel (105) and a sliding connection portion (170). The supporting seat channel (105) extends through the first side (111) and the second side (112). The connecting pipe (120) is connected to the first side (111) of the supporting seat (101) and is in communication with the supporting seat channel (105). The sliding connection portion (170) is configured to be slidable in a first direction relative to a mounting location to connect the connector (100) to the mounting location.

### RELATED APPLICATION

The present application claims the benefit of Chinese Patent Application No. 202510028554.0, filed Jan. 8, 2025, titled “Connector and Connector Assembly,” the contents of which are hereby incorporated by reference.

### TECHNICAL FIELD

The present disclosure relates to a connector and a connector assembly, and in particular to a connector and connector assembly for a battery pack cooling plate.

### BACKGROUND

In a battery pack, a cooling device is provided to cool the battery pack. The cooling device is provided with a cooling medium channel which can be in communication with an external cooling pipeline to introduce an external cooling medium into the cooling device. The cooling device has an interface port mounted with a connector, through which the cooling device is in communication with the cooling pipeline.

### SUMMARY

The present disclosure relates generally to a connector device, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a connector according to the present disclosure.

FIG. 1B is a perspective view of the connector in FIG. 1A from a second angle.

FIG. 1C is a perspective view of the connector in FIG. 1A from a third angle.

FIG. 1D is a side view of the connector in FIG. 1A viewed from the side.

FIG. 2 is a sectional view of the connector in FIG. 1A.

FIG. 3A is an exploded view of a connector assembly according to the present disclosure.

FIG. 3B is a perspective view of the connector assembly in FIG. 3A in its assembled state.

FIG. 4A is a perspective view of the connecting seat in FIG. 3A.

FIG. 4B is a sectional view of the connecting seat in FIG. 4A.

FIG. 5A is a side view showing the connector about to be mounted into the connecting seat.

FIG. 5B is a sectional view of FIG. 5A.

FIG. 5C is a side view showing the connector partially mounted into the connecting seat.

FIG. 5D is a sectional view of FIG. 5C.

FIG. 5E is a side view showing the connector mounted in place in the connecting seat.

FIG. 5F is a sectional view of FIG. 5E.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a connector comprising a supporting seat and a connecting pipe. The supporting seat has a first side and a second side opposite to each other and comprises a supporting seat channel and a sliding connection portion. The supporting seat channel extends through the first side and the second side. The connecting pipe is connected to the first side of the supporting seat and is in communication with the supporting seat channel. The sliding connection portion is configured to be slidable in a first direction relative to a mounting location to connect the connector to the mounting location.

In the connector as described above, the sliding connection portion comprises guiding portions extending in the first direction. The guiding portions are configured to cooperate with the mounting location to guide the connector to slide in the first direction. The guiding portions comprise slots or ribs extending in the first direction.

The connector as described above is configured to be connected to a component through the mounting location. The first direction and an extension direction of the component form an angle ranging from 0° to 30°. The first direction and an extension direction of the supporting seat channel form an angle ranging from 75° to 105°.

In the connector as described above, the second side of the supporting seat comprises a sealing surface extending obliquely in the first direction away from the mounting location.

In the connector as described above, the sealing surface is inclined at an angle ranging from 0° to 30° relative to the first direction.

In the connector as described above, a sealing ring disposed on the second side of the supporting seat.

In the connector as described above, the sealing ring is disposed surrounding the supporting seat channel and protrudes above the sealing surface.

In the connector as described above, the sealing surface extends beyond an outer edge of the sealing ring.

In the connector as described above, the guiding portions comprise slots, and the supporting seat comprises base plate side edges and elastic arms extending in the first direction. The elastic arms are connected to the base plate side edges at their proximal ends. The elastic arms are at a distance from the base plate side edges to form the slots. The elastic arms and the base plate side edges define openings at the distal ends of the elastic arms.

In the connector as described above, the base plate side edges extend obliquely away from the elastic arms at locations near the openings to form guiding slopes.

In the connector as described above, the elastic arms have protrusions extending beyond the inner surfaces of the elastic arms toward the base plate side edges at their distal ends. The protrusions are configured to cooperate with the mounting location to restrict the connector from moving in a direction opposite to the first direction to disengage from the mounting location.

In the connector as described above, the supporting seat comprises a front end portion extending in the first direction and located downstream of the sealing surface in the first direction.

The connector as described above is used for connection to a battery pack cooling plate.

The present disclosure further provides a connector assembly comprising a connector as described above and a connecting seat. The connecting seat comprises: a connecting seat channel configured to be in communication with the supporting seat channel; and a sliding fit portion configured to cooperate with the sliding connection portion of the connector to connect the connector to the connecting seat.

In the connector assembly as described above, the connecting seat is fixedly connected to a surface of a battery pack cooling plate and has a thickness not exceeding the thickness of the battery pack cooling plate.

In the connector assembly as described above, one of the sliding fit portions and the sliding connection portion comprises slots extending in the first direction, and the other thereof comprises ribs extending in the first direction and slidable in the slots to guide the connector to slide in the first direction.

The connector assembly according to the present disclosure comprises a connecting seat and a connector. The connecting seat is fixedly connected to a component, and the connector is detachably mounted into the connecting seat. During transportation, the connecting seat can be transported together with the component, while the connector is transported separately. The connector is then mounted into the connecting seat prior to use. The connecting seat has a relatively small thickness, which saves space when transporting the component.

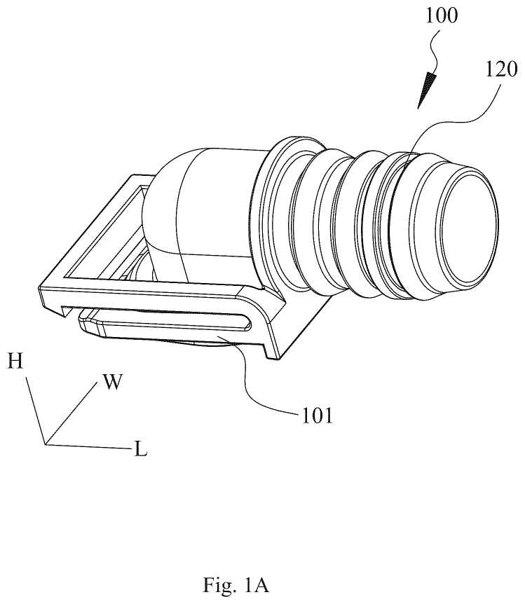

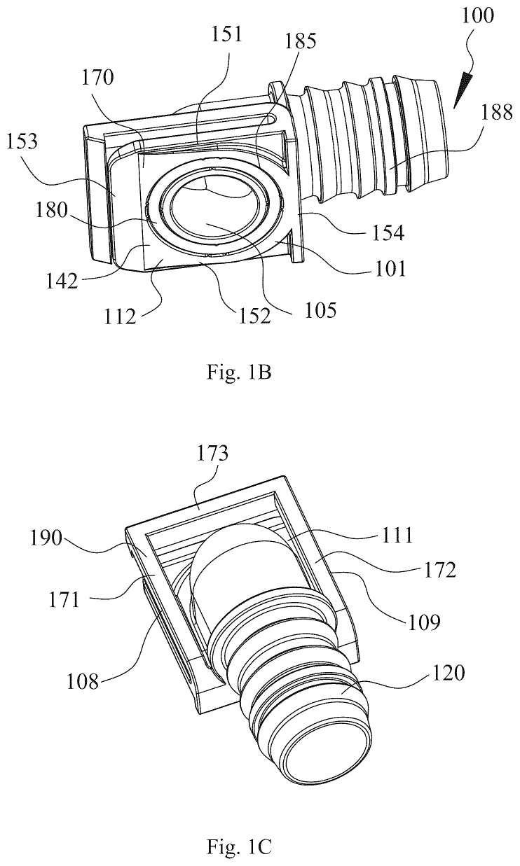

FIG. 1A is a perspective view of a connector according to the present disclosure, FIG. 1B is a perspective view of the connector in FIG. 1A from a second angle, FIG. 1C is a perspective view of the connector in FIG. 1A from a third angle, and FIG. 1D is a side view of the connector in FIG. 1A viewed from the side.

As shown in FIGS. 1A to 1C, the connector 100 has a height direction H, a length direction L and a width direction W. In the present disclosure, a first direction is an insertion direction of the connector extending in the length direction L, and the height direction H is the thickness direction of the connector. The thickness direction is substantially perpendicular to the first direction. The connector 100 includes a supporting seat 101, a connecting pipe 120 and a sealing ring 180. The supporting seat 101 is substantially in the shape of a flat plate and extends in the width direction W and the length direction L. The supporting seat 101 has a first side 111 and a second side 112 arranged opposite to each other, and a supporting seat channel 105. The supporting seat channel 105 extends through the first side 111 and the second side 112 of the supporting seat 101. The connecting pipe 120 is connected to the first side 111 of the supporting seat 101 and is in communication with the supporting seat channel 105. The connecting pipe 120 extends from the first side 111 of the supporting seat 101 in a direction substantially parallel to the supporting seat 101. The connecting pipe 120 is provided with a plurality of annular protrusions 188 on its outer side to facilitate connection to an external pipeline.

In an embodiment of the present disclosure, the extension direction of the supporting seat channel 105 is perpendicular to the first direction. In another embodiment of the present disclosure, there is an angle from 75° to 105° between the extension direction of the supporting seat channel 105 and the first direction.

The supporting seat 101 includes a base plate 170 and an elastic portion 190. The elastic portion 190 is connected to the base plate 170 at one end and is movable relative to the base plate 170 at the other end, so that the elastic portion 190 is elastic. The elastic portion 190 includes a pair of elastic arms 171 and 172 and a connecting beam 173. The base plate 170 includes a pair of base plate side edges 151 and 152 arranged opposite to each other, and a front portion 153 and a rear portion 154 arranged opposite to each other. In the length direction of the connector, the direction from the rear portion 154 to the front portion 153 is the first direction D1 described in the present disclosure (see FIG. 1D). The elastic arms 171 and 172 are each connected to the base plate 170 at one end, and are connected to each other at the other ends by means of the connecting beam 173. The connections of the elastic arms 171 and 172 with the base plate 170 are near the rear portion 154 and are respectively located at one side of the base plate side edges 151 and 152 in the height direction. The base plate side edges 151 and 152 and the elastic arms 171 and 172 extend in the length direction of the connector, that is, in the first direction. The elastic arms 171 and 172 have mutually symmetrical structures, and the elastic arm 171 is taken as an example to describe the structure thereof.

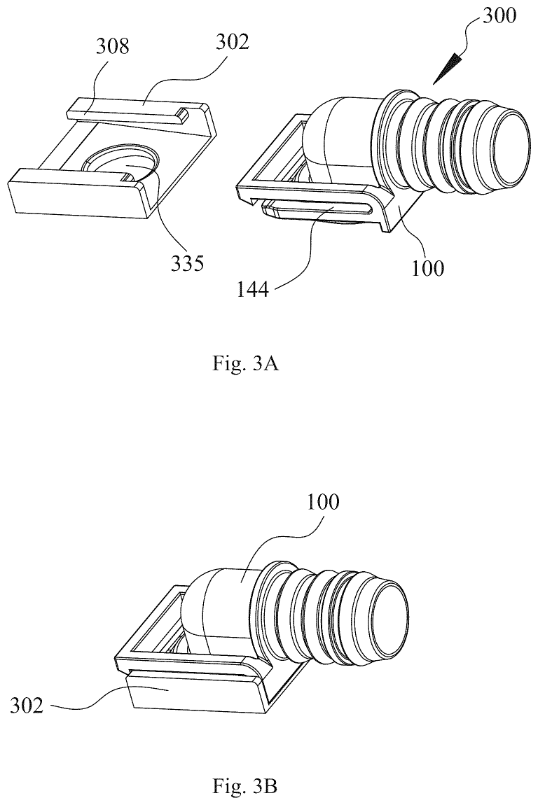

The elastic arm 171 is connected at its proximal end to a side of the base plate side edge 151 near the rear portion 154 and extends toward the front portion 153 in the first direction. The elastic arm 171 is at a distance from the base plate side edge 151 to form a slot 144, which is of a substantially elongated shape and extends in the first direction. The slot 144 has an opening 166 at one end, which is located at the end of the slot 144 near the front portion 153. The opening 166 is formed between a distal end of the elastic arm 171 and the base plate side edge 151. The base plate side edge 151 extends obliquely away from the elastic arm 171 at a location near the opening 166 to form a guiding slope 178, so that a guiding section 169 is formed in the slot 144 near the opening 166 to guide a corresponding structure of a mounting location (such as the connecting seat 302 shown in FIGS. 3A and 3B) into the slot 144. The elastic arm 171 is provided with a protrusion 168 at its distal end which extends beyond an inner side surface of the elastic arm 171 toward the base plate side edge 151 and has a limiting surface 129 facing the proximal end of the elastic arm 171. The limiting surface 129 extends substantially in the height direction and the width direction of the connector. The protrusion 168 is configured to cooperate with the mounting location to restrict the connector from moving in a direction opposite to the first direction to disengage from the mounting location.

In this embodiment, the elastic arm 171, the base plate side edge 151, and the slot 144 defined by the elastic arm 171 and the base plate side edge 151 jointly form a sliding connection portion 170. The slot 144 forms a guiding portion which guides the connector to slide in the first direction relative to the mounting location.

The second side 112 of the supporting seat 101 (i.e., the side of the base plate 170 away from the connecting pipe 120) includes a sealing surface 142, which extends obliquely in the first direction away from the mounting location. The sealing surface 142 is provided with an annular groove 185 surrounding the supporting seat channel 105. The annular groove 185 is used to mount the sealing ring 180. The sealing ring 180 is made of an elastic material and used to form a seal with the mounting location. The sealing ring 180 is arranged to protrude above the sealing surface 142. The sealing surface 142 extends beyond an outer edge of the sealing ring 180.

The supporting seat 101 further includes a front end portion 158 which extends in the first direction and is located downstream of the sealing surface 142 in the first direction. That is, the front end portion 158 extends in the first direction from the end of the sealing surface 142 near the front portion 153 of the base plate 170. The front end portion 158 is defined between the base plate side edges 151 and 152. There is an angle formed between a lower surface of the front end portion 158 and the sealing surface 142.

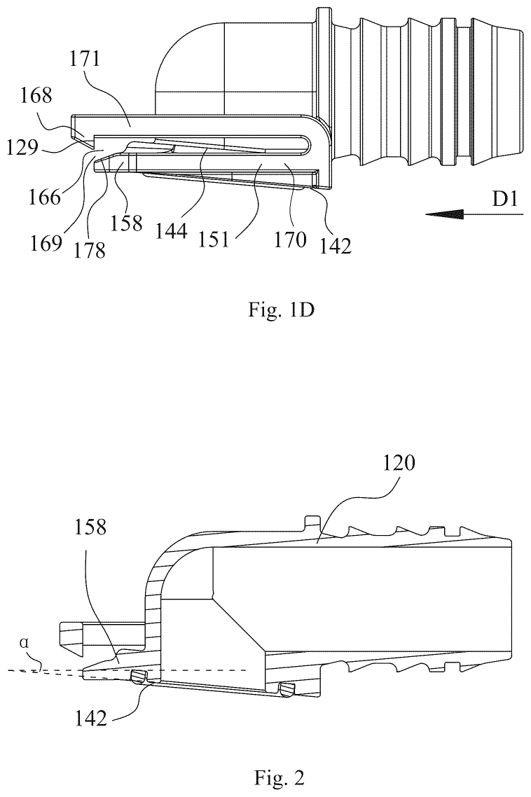

FIG. 2 is a sectional view of the connector in FIG. 1A. As shown in FIG. 2, there is an angle α formed between the sealing surface 142 and the first direction. In an embodiment of the present disclosure, the angle α ranges from 0° to 30°. In an embodiment of the present disclosure, the angle α ranges from 0° to 25°. In an embodiment of the present disclosure, the angle α ranges from 0° to 20°. In an embodiment of the present disclosure, the angle α ranges from 0° to 15°. In an embodiment of the present disclosure, the angle α ranges from 0° to 10°. The angle of the sealing surface 142 makes it easy for the connector to be mounted to the mounting location and to form a seal with the mounting location.

FIG. 3A is an exploded view of a connector assembly according to the present disclosure, and FIG. 3B is a perspective view showing the connector assembly in FIG. 3A in an assembled state.

As shown in FIGS. 3A and 3B, the connector assembly 300 includes the connector 100 and a connecting seat 302. In the connector assembly 300, the connecting seat 302 serves as the mounting location as described in the present disclosure. The connector 100 can be mounted into the connecting seat 302 in the first direction to connect the connector 100 to the connecting seat 302.

As shown in FIG. 3A, the connecting seat 302 has a connecting seat channel 335 and a sliding fit portion 308. The sliding fit portion 308 cooperates with the sliding connection portion of the connector 100 to connect the connector 100 to the connecting seat 302. When the connector 100 is connected in place to the connecting seat 302, the connecting seat channel 335 is aligned with the supporting seat channel 105.

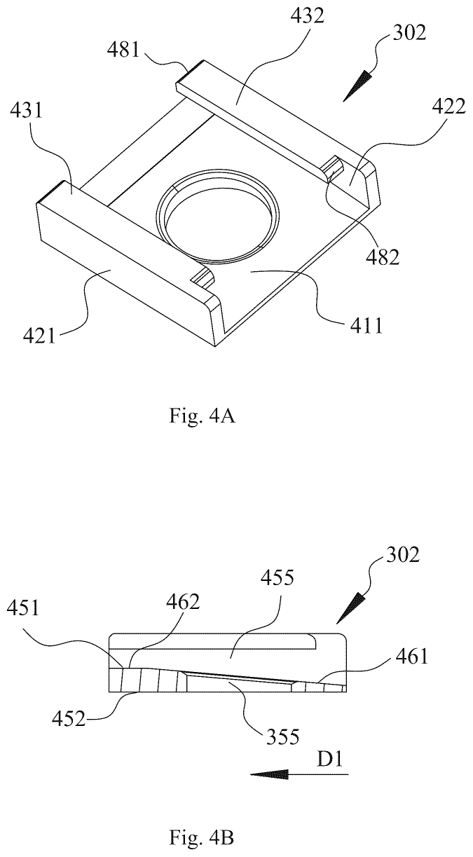

FIG. 4A is a perspective view of the connecting seat 302 in FIG. 3A, and FIG. 4B is a sectional view of the connecting seat 302 in FIG. 4A. As shown in FIGS. 4A and 4B, the connecting seat 302 includes a bottom plate 411 and a pair of side portions 421 and 422. The side portions 421 and 422 respectively extend from the opposite sides of the bottom plate 411. The sliding fit portion 308 includes bent portions 431 and 432 bending toward each other from the respective distal ends of the side portions 421 and 422. The bent portions 431 and 432 each extends in the first direction to form a rib. The bent portions 431 and 432 can enter into and slide in the corresponding slots 144 of the connector 100. The positions of the slots 144 and the bent portions 431 and 432 may be interchanged.

The bottom plate 411 has an upper side 451 and a lower side 452, and the side portions 421 and 422 are connected to the upper side 451 of the bottom plate 411. The lower side 452 is connected to a component such as a battery pack cooling plate. The upper side 451 has an inclined surface 461 and a front surface 462. The inclined surface 461 extends obliquely substantially in the first direction away from the lower side 452. The front surface 462 is located downstream of the inclined surface 461 in the first direction and extends substantially in the first direction. The inclination angle of the inclined surface 461 fits with the inclination angle of the sealing surface 142.

Mounting spaces 455 having a gradually decreasing thickness in the first direction are respectively formed between the bent portions 431 and 432 and the inclined surface 461. The mounting spaces 455 can respectively accommodate the base plate side edges 151 and 152. When the base plate 170 of the connector 100 moves into the mounting spaces 455 along the first direction, the gradually decreasing thickness of the mounting spaces 455 is conducive to the mounting of the base plate 170. Each of the bent portions 431 and 432 has a front end 481 and a rear end 482.

In the present disclosure, the connecting seat 302 has a small thickness. In an embodiment of the present disclosure, the thickness of the connecting seat 302 does not exceed the thickness of the battery pack cooling plate. In another embodiment of the present disclosure, the thickness of the connecting seat 302 does not exceed ⅔ of the thickness of the battery pack cooling plate.

In an embodiment of the present disclosure, the first direction is parallel to the extension direction of the battery pack cooling plate. In another embodiment of the present disclosure, there is an angle ranging from 0° to 15° between the first direction and the extension direction of the battery pack cooling plate. In still another embodiment of the present disclosure, there is an angle ranging from 0° to 30° between the first direction and the extension direction of the battery pack cooling plate.

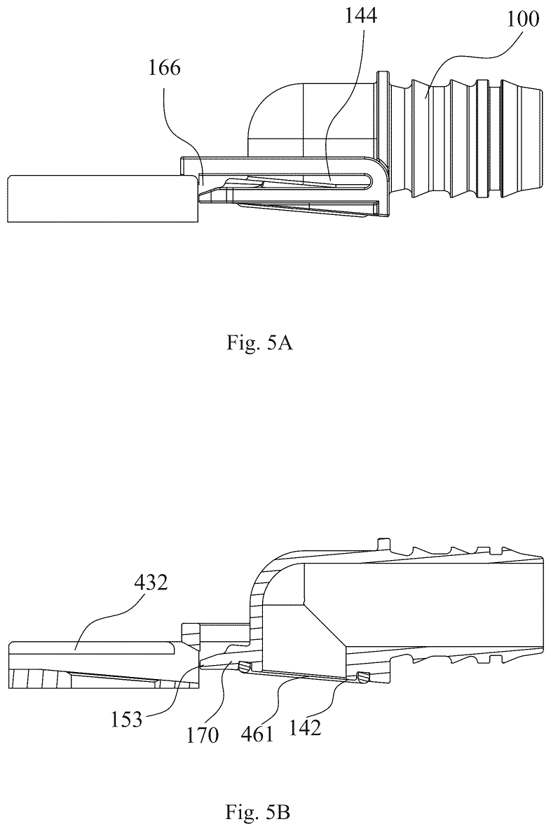

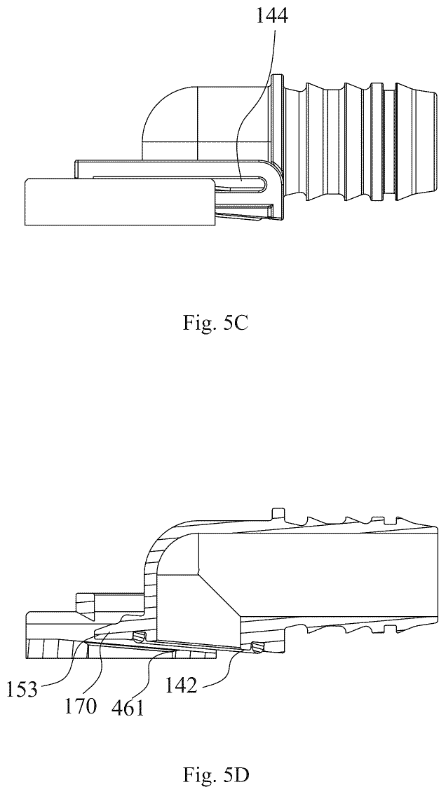

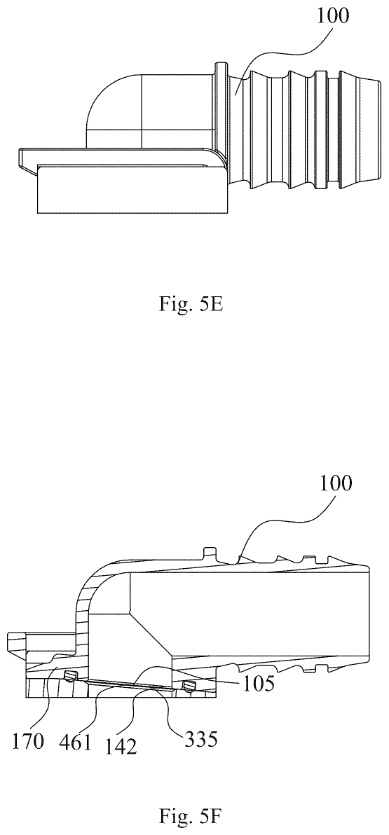

FIG. 5A is a side view showing the connector about to be mounted into the connecting seat, FIG. 5B is a sectional view of FIG. 5A, FIG. 5C is a side view showing the connector partially mounted into the connecting seat, FIG. 5D is a sectional view of FIG. 5C, FIG. 5E is a side view showing the connector mounted in place in the connecting seat, and FIG. 5F is a sectional view of FIG. 5E.

As shown in FIGS. 5A and 5B, to mount the connector 100 into the connecting seat 302, first align the openings 166 of the slots 144 of the connector 100 with the bent portions 431 and 432 of the connecting seat 302. The connector 100 is pushed in the first direction, causing the elastic arms 171 and 172 to deform upward to expand the openings of the slots 144 such that the bent portions 431 and 432 enter the slots 144. The slots 144 are sized to match the dimensions of the bent portions 431 and 432, and both the slots 144 and the bent portions 431 and 432 extend in the first direction, so as to guide the connector 100 to move in the first direction relative to the connecting seat 302. In this case, the front portion 153 of the base plate 170 is about to enter the mounting spaces 455. The mounting space 455 has a greater thickness at the entrance, making it easy for the base plate 170 to enter.

As shown in FIGS. 5C and 5D, the connector 100 is pushed to move in the first direction, and the bent portions 431 and 432 partially enter the slots 144. The base plate 170 enter the mounting spaces 455. In this case, since the sealing surface 142 of the base plate 170 and the inclined surface 461 of the connecting seat 302 are arranged obliquely, the sealing surface 142 is at a distance from the inclined surface 461, and the sealing ring 180 cannot come into contact with the slope 461 at this stage.

As shown in FIGS. 5E and 5F, the connector 100 is further pushed to move in the first direction, and the protrusions 168 of the elastic arms 171 and 172 move past the bent portions 431 and 432. Consequently, the elastic arms 171 and 172 restore deformation, and abut against the front ends 481 of the bent portions 431 and 432. Accordingly, the front ends 481 of the bent portions 431 and 432 cooperate with the protrusions 168 to restrict the connector 100 from moving in a direction opposite to the first direction relative to the connecting seat 302 to disengage from the connecting seat 302. That is, the connector 100 is restricted from moving in a pull-out direction.

At the positions shown in FIGS. 5E and 5F, the supporting seat channel 105 is aligned with the connecting seat channel 335. The sealing surface 142 is closely abuts the inclined surface 461 so that the sealing ring 180 is compressed to seal between the sealing surface 142 and the inclined surface 461. The sealing ring 180 is disposed around the supporting seat channel 105 and the connecting seat channel 335, which can avoid leakage of fluid when the fluid flows in the supporting seat channel 105 and the connecting seat channel 335.

The front end portion 158 of the base plate 170 is clamped between the bent portions 431 and 432 and the bottom plate 411, restricting the connector 100 from moving in the height direction relative to the connecting seat 302. Thus, the connector 100 is stably connected to the connecting seat 302.

Since the sealing surface 142 and the inclined surface 461 are arranged obliquely relative to the first direction, the sealing surface 142 gradually approaches the inclined surface 461 during the process of mounting the connector 100 into the connecting seat 302. This design prevents the sealing ring 180 from deforming due to unnecessary friction against the inclined surface 461 before the connector 100 is mounted in place. In the present disclosure, the front portion of the sealing ring 180 comes into contact with the inclined surface 461 after passing the connecting seal channel 335, avoiding deformation or displacement of the sealing ring 180 due to premature contact with the inclined surface 461.

In the present disclosure, the connector 100 and the connecting seat 302 form a detachable assembly, and the connecting seat 302 is fixedly connected to a component such as a battery pack cooling plate. In the present disclosure, the battery pack cooling plate, to which the connecting seat 302 is fixed, and the connector 100 can be transported separately and mounted at the place of use. The connecting seat 302 has a small thickness, which is conducive to saving space during transportation of the battery pack cooling plate.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A connector, comprising:
a supporting seat having a first side and a second side opposite to each other and comprising a supporting seat channel and a sliding connection portion, and the supporting seat channel extending through the first side and the second side; and
a connecting pipe connected to the first side of the supporting seat and in communication with the supporting seat channel;
wherein the sliding connection portion is configured to be slidable in a first direction relative to a mounting location to connect the connector to the mounting location.

2. The connector according to claim 1, wherein
the sliding connection portion comprises guiding portions extending in the first direction, the guiding portions being configured to cooperate with the mounting location to guide the connector to slide in the first direction, wherein the guiding portions comprise slots or ribs extending in the first direction.

3. The connector according to claim 1, wherein
the connector is configured to be connected to a component through the mounting location, and the first direction and an extension direction of the component form an angle ranging from 0° to 30°; and
the first direction and an extension direction of the supporting seat channel form an angle ranging from 75° to 105°.

4. The connector according to claim 1, wherein
the second side of the supporting seat comprises a sealing surface extending obliquely in the first direction away from the mounting location.

5. The connector according to claim 4, wherein
the sealing surface is inclined at an angle ranging from 0° to 30° relative to the first direction.

6. The connector according to claim 4, further comprising:
a sealing ring disposed on the second side of the supporting seat.

7. The connector according to claim 5, wherein
the sealing ring is disposed surrounding the supporting seat channel and protrudes above the sealing surface.

8. The connector according to claim 5, wherein the sealing surface extends beyond an outer edge of the sealing ring.

9. The connector according to claim 2, wherein
the guiding portions comprise slots, and the supporting seat comprises base plate side edges and elastic arms extending in the first direction, the elastic arms being connected to the base plate side edges at their proximal ends, the elastic arms being at a distance from the base plate side edges to form the slots, and the elastic arms and the base plate side edges defining openings at the distal ends of the elastic arms.

10. The connector according to claim 9, wherein
the base plate side edges extend obliquely away from the elastic arms at locations near the openings to form guiding slopes.

11. The connector according to claim 9, wherein
the elastic arms have protrusions extending beyond the inner surfaces of the elastic arms toward the base plate side edges at their distal ends, the protrusions being configured to cooperate with the mounting location to restrict the connector from moving in a direction opposite to the first direction to disengage from the mounting location.

12. The connector according to claim 1, wherein
the supporting seat comprises a front end portion extending in the first direction and located downstream of the sealing surface in the first direction.

13. The connector according to claim 1, wherein
the connector is used for connection to a battery pack cooling plate.

14. A connector assembly, comprising:
a connector according to any one of claims 1; and
a connecting seat comprising:
a connecting seat channel configured to be in communication with the supporting seat channel; and
a sliding fit portion configured to cooperate with the sliding connection portion of the connector to connect the connector to the connecting seat.

15. The connector assembly according to claim 14, wherein
the connecting seat is fixedly connected to a surface of a battery pack cooling plate and have a thickness not exceeding a thickness of the battery pack cooling plate.

16. The connector assembly according to claim 15, wherein
one of the sliding fit portion and the sliding connection portion comprises slots extending in the first direction, and the other thereof comprises ribs extending in the first direction and slidable in the slots to guide the connector to slide in the first direction.
